(19) United States
(12) Patent Application Publication
(10) Pub. No.: US 2020/0356624 A1
(43) Pub. Date: Nov. 12, 2020

(54) COLLABORATIVE DOCUMENT EDITING SYSTEM AND METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: FU-FA CAI, Shenzhen (CN); XIN LU, Shenzhen (CN); HUI-FENG LIU, Shenzhen (CN); WEN TANG, New Taipei (TW)

(21) Appl. No.: 16/546,571

(22) Filed: Aug. 21, 2019

(30) Foreign Application Priority Data
May 9, 2019 (CN) 201910393194.9

(51) Int. Cl. G06F 17/22; G06F 17/24; G06Q 10/10

(52) U.S. Cl. CPC G06F 17/2288; G06Q 10/101; G06F 17/24; G06F 17/2211

(57) ABSTRACT

A collaborative document editing system includes a server and at least two user terminals communicatively coupled to the server through a network. The server distributes a collaborative editing task to the two user terminals. The collaborative editing task includes a document to be edited. The two user terminals send local operation records to the server. The server records the local operation records of the user terminals. The server receives an edit operation command from the two user terminals. The server adds the edit operation commands of the user terminals to an operation queue and sends the edit operation commands to the user terminals according to the operation queue. The user terminals receive the edit operation commands according to the operation queue and update the document according to the local operation record corresponding to the edit operation commands.

### FIELD

The subject matter herein generally relates to document editing technology, and more particularly to a collaborative document editing system and method.

### BACKGROUND

Generally, when a job requires multi-person collaborative editing, each editor needs to install specific electronic document editing software. The editing software needs to be the same or similar version. However, it may be difficult to track changes of the document edited by different editors, and may not practical to merge changes performed by different editors into a single document.

### BRIEF DESCRIPTION OF THE DRAWINGS

Implementations of the present disclosure will now be described, by way of embodiments, with reference to the attached figures.

FIG. 1 is a schematic diagram of an embodiment of a collaborative document editing system.

FIG. 2 is a flowchart of an embodiment of a collaborative document editing method.

FIG. 3 is a block diagram of a collaborative document editing program.

FIG. 4 is a block diagram of a user terminal of the collaborative document editing system.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

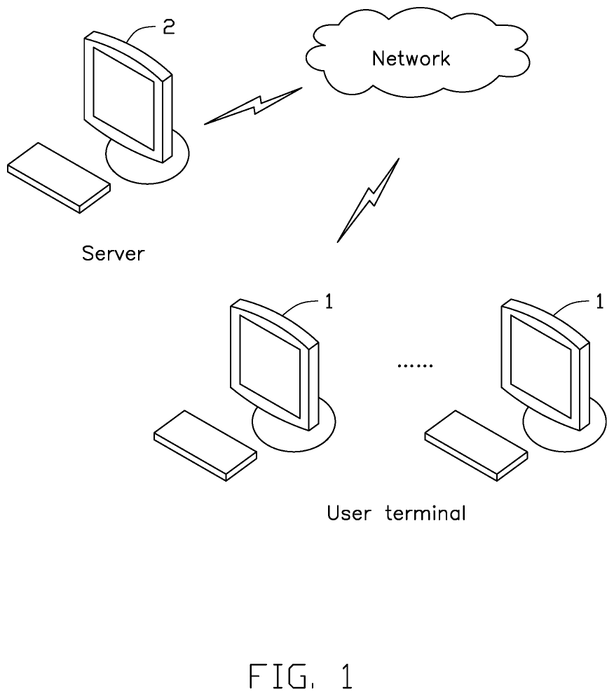

FIG. 1 shows a schematic diagram of an embodiment of a collaborative document editing system.

The collaborative document editing system includes at least two user terminals 1 and a server 2. The user terminals 1 are communicatively coupled to the server 2 through a network. The network may be a wired network or a wireless network, such as radio, Wireless Fidelity (WIFI), cellular, satellite, broadcast, and the like.

The user terminal 1 may be a smart phone, a tablet computer, a laptop computer, a desktop computer, or other electronic device having document editing functions installed.

The server 2 may be an electronic device such as a smartphone, a tablet, a laptop computer, a desktop computer, a cloud server, and the like. In other embodiments, functions of the server 2 may be implemented by the at least two user terminals 1.

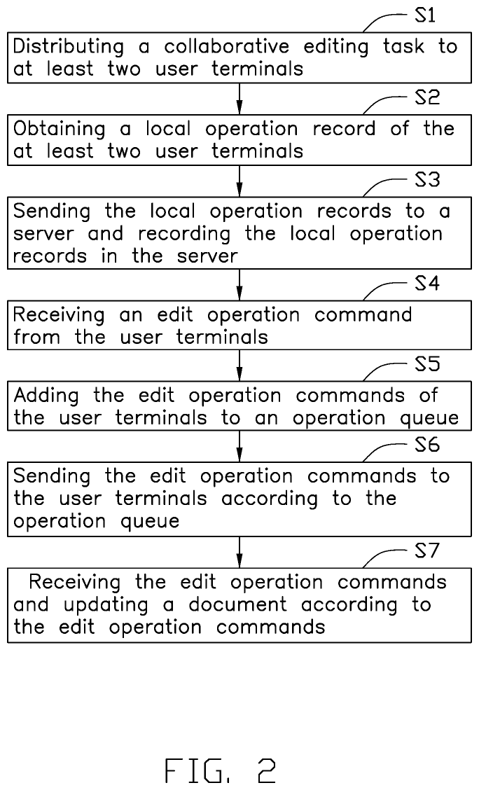

FIG. 2 shows a flowchart of a collaborative document editing method applied in the collaborative document editing system. The order of blocks in the flowchart may be changed according to different requirements, and some blocks may be omitted.

At block S1, the server 2 distributes a collaborative editing task to the user terminals 1.

For example, the server 2 distributes the collaborative editing task to two user terminals 1 (hereinafter a “user terminal A” and a “user terminal B”). The collaborative editing task includes at least one document to be edited and information of the at least one document to be edited, such as a document name, the user terminals to edit the document, and edit positions of the document. For example, the document name is “work summary.xlx”, the user terminals to edit the document include “user terminal A” and “user terminal B”, and the edit positions include “column A1” to be edited by user terminal A and “column A2” to be edited by user terminal B. The collaborative editing task may include different types of documents, such as spreadsheet documents, rich text documents, or presentation documents to be edited.

In one embodiment, any of the user terminals 1 may send a request to the server 2 to add another user terminal 1 to the collaborative editing task. The request includes the document name, an IP address of the user terminal 1 to add to the collaborative editing task, an edit position of the document, and an edit time to the server 2. Then, the server 2 can distribute the collaborative editing task to the added user terminal 1.

At block S2, the user terminals 1 obtain a local operation record.

In one embodiment, the local operation record includes the document names, edit operations, contents of the edit operations, types of the edit operations, edit positions, and edit completion times of the edited documents.

For example, the document in the collaborative editing task is an EXCEL document, the document name is “annual report”, and the types of edit operations performed on the user terminal A on the document “annual report” include adding, deleting, and modifying operations. The user terminal A obtains the local operation record according to the edit operations performed by a user on the user terminal A. Similarly, the user terminal B obtains the local operation record according to the edit operations performed by a user on the user terminal B.

At block S3, the user terminals 1 send the local operation records to the server 2, and the server 2 records the local operation records.

At block S4, the server 2 receives an edit operation command from the user terminals 1.

In one embodiment, the edit operation command corresponds to the local operation record. For example, the edit operation command received by the server 2 from the user terminal A performs an edit operation to the A1 column of “work summary.xlx”, wherein the edit operation is to add “the project has been completed”, and the edit time is 2019-03-22, 16:25. The edit operation command received by the server 2 from the user terminal B performs an edit operation to the A2 column of “work summary.xlx”, wherein the edit operation is to add “the project has been completed”, and the edit time is 2019-03-22, 16:20.

At block S5, the edit operation commands of the user terminals 1 are added to an operation queue.

In one embodiment, before adding the edit operation commands to the operation queue, a conflict determination process is performed on the edit operation commands sent by the user terminals 1. The conflict determination process determines whether the user terminals 1 have performed editing operations on the same position of the same document. If the user terminals 1 have performed editing operations on the same position of the same document, then there is a conflict, and if not, then there is no conflict. If the edit operation commands do not conflict, the edit operation commands are added to the operation queue. If the edit operation commands have a conflict, the conflict is resolved according to a preset program, and then the resolved edit operation commands are sent to the corresponding user terminals. If the server 2 cannot resolve the conflict according to the preset program, the conflict is sent to the user terminals for processing, and the resolved conflict is sent by the user terminals.

In one embodiment, the preset program resolves the conflict according to the type of the edit operations, a priority of the types of edit operations, a sequence of the edit operations, and a priority of the user terminals 1.

For example, the edit operation command received by the server 2 from the user terminal A adds the edit operation to the A3 column of “work summary.xlx”, wherein the added content is “the project has been completed”, and the edit time is 2019-03-20, 16:20. The edit operation command received by the server 2 from the user terminal B adds the edit operation to the A3 column of “work summary.xlx”, wherein the added content is “the project has been completed, the customer has a complaint”, and the edit time is 2019-03-22, 10:20. The user terminal A and the user terminal B edit the same position of the document “work summary.xlx”. The server 2 determines that the types of the edit operations are the same. Since the conflict is the same type of edit, the most recent edit operation command is saved.

In another example, if the user terminal A deletes the A3 column, and the user terminal B modifies the A3 column, the priority of the user terminal A and the user terminal B is determined according to a database. If the priority of the user terminal B is higher than the priority of the user terminal A, the edit operation command of the user terminal B is saved. If the priority of the user terminal A and the user terminal B is the same, the server 2 sends the conflict to the user terminal A and the user terminal B to resolve, and the user terminal A and the user terminal B send the resolution to the server 2.

After the server 2 determines that the conflict determination process is completed, the edit operation commands are added to the operation queue. The edit operation commands are arranged in the operation queue according to a time of receiving the edit operation commands. In another embodiment, the edit operation commands are arranged in the operation queue according to a preset order of edit operations or a preset order of edit positions.

At block S6, the server 2 sends the edit operation commands to the user terminals 1 according to the operation queue.

For example, the server 2 sends the edit operation command of the user terminal A to the user terminal B, and sends the edit operation command of the user terminal B to the user terminal A.

At block S7, the at least two user terminals 1 receive the edit operation commands and update the document according to the edit operation commands.

For example, the user terminal A receives the edit operation command of the user terminal B, wherein the edit operation command of the user terminal B is to delete the A2 column of the document “annual report”.

In one embodiment, the edit operation commands are received according to a preset rule in the respective user terminals 1.

The preset rule may be used to determine whether the edit operation commands need to be received according to the priority of the user terminals, the IP address of the user terminals, and the like.

For example, the user terminal A receives the edit operation command of the user terminal B to delete the A2 column of the document “annual report”. If the user terminal A has the priority to receive the edit operation command of the user terminal B, the user terminal A runs the edit operation command of the user terminal B and updates the document according to the edit operation command.

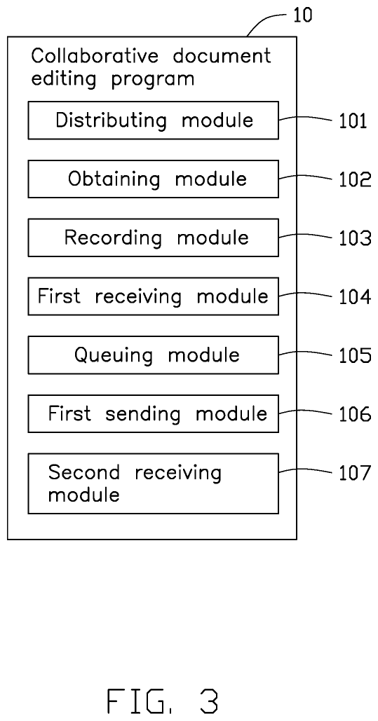

FIG. 3 shows a block diagram of a collaborative document editing program 10. The collaborative document editing program 10 may be applied in the server 2 and the at least two user terminals 1. The collaborative document editing program 10 may include a plurality of functional modules composed of program code segments. The program code segments may be stored in a memory of the server 2 and executed by a processor of the server 2 to implement functions of the functional modules.

In one embodiment, the functional modules may include a distributing module 101, an obtaining module 102, a recording module 103, a first receiving module 104, a queuing module 105, a first sending module 106, and a second receiving module 107.

The distributing module 101 is implemented in the server 2 and distributes a collaborative editing task to the user terminals 1.

For example, the distributing module 101 distributes the collaborative editing task to two user terminals 1 (hereinafter a “user terminal A” and a “user terminal B”). The collaborative editing task includes at least one document to be edited and information of the at least one document to be edited, such as a document name, the user terminals to edit the document, and edit positions of the document. For example, the document name is “work summary.xlx”, the user terminals to edit the document include “user terminal A” and “user terminal B”, and the edit positions include “column A1” to be edited by user terminal A and “column A2” to be edited by user terminal B. The collaborative editing task may include different types of documents, such as spreadsheet documents, rich text documents, or presentation documents to be edited.

In one embodiment, any of the user terminals 1 may send a request to the server 2 to add another user terminal 1 to the collaborative editing task. The request includes the document name, an IP address of the user terminal 1 to add to the collaborative editing task, an edit position of the document, and an edit time to the server 2. Then, the distributing module 101 can distribute the collaborative editing task to the added user terminal 1.

The obtaining module 102 is implemented in the user terminals 1 and obtains a local operation record.

In one embodiment, the local operation record includes the document names, edit operations, contents of the edit operations, types of the edit operations, edit positions, and edit completion times of the edited documents.

For example, the document in the collaborative editing task is an EXCEL document, the document name is “annual report”, and the types of edit operations performed on the user terminal A on the document “annual report” include adding, deleting, and modifying operations. The user terminal A obtains the local operation record according to the edit operations performed by a user on the user terminal A. Similarly, the user terminal B obtains the local operation record according to the edit operations performed by a user on the user terminal B.

The recording module 103 is implemented in the server 2. The user terminals 1 send the local operation records to the server 2, and the recording module 103 records the local operation records.

The first receiving module 104 is implemented in the server 2 and receives an edit operation command from the user terminals 1.

In one embodiment, the edit operation command corresponds to the local operation record. For example, the edit operation command received by the server 2 from the user terminal A performs an edit oeration to the A 1 column of “work summary.xlx”, wherein the edit operation is to add “the project has been completed”, and the edit time is 2019-03-22, 16:25. The edit operation command received by the server 2 from the user terminal B performs an edit operation to the A2 column of “work summary.xlx”, wherein the edit operation is to add “the project has been completed”, and the edit time is 2019-03-22, 16:20.

The queuing module 105 is implemented in the server 2 and adds the edit operation commands to an operation queue.

In one embodiment, before adding the edit operation commands to the operation queue, a conflict determination process is performed on the edit operation commands sent by the user terminals 1. The conflict determination process determines whether the user terminals 1 have performed editing operations on the same position of the same document. If the user terminals 1 have performed editing operations on the same position of the same document, then there is a conflict, and if not, then there is no conflict. If the edit operation commands do not conflict, the edit operation commands are added to the operation queue. If the edit operation commands have a conflict, the conflict is resolved according to a preset program, and then the resolved edit operation commands are sent to the corresponding user terminals. If the queuing module 105 cannot resolve the conflict according to the preset program, the conflict is sent to the user terminals for processing, and the resolved conflict is sent by the user terminals.

In one embodiment, the preset program resolves the conflict according to the type of the edit operations, a priority of the types of edit operations, a sequence of the edit operations, and a priority of the user terminals 1.

For example, the edit operation command received by the queuing module 105 from the user terminal A adds the edit operation to the A3 column of “work summary.xlx”, wherein the added content is “the project has been completed”, and the edit time is 2019-03-20, 16:20. The edit operation command received by the queuing module 105 from the user terminal B adds the edit operation to the A3 column of “work summary.xlx”, wherein the added content is “the project has been completed, the customer has a complaint”, and the edit time is 2019-03-22, 10:20. The user terminal A and the user terminal B edit the same position of the document “work summary.xlx”. The server 2 determines that the types of the edit operations are the same. Since the conflict is the same type of edit, the most recent edit operation command is saved.

In another example, if the user terminal A deletes the A3 column, and the user terminal B modifies the A3 column, the priority of the user terminal A and the user terminal B is determined according to a database. If the priority of the user terminal B is higher than the priority of the user terminal A, the edit operation command of the user terminal B is saved. If the priority of the user terminal A and the user terminal B is the same, the server 2 sends the conflict to the user terminal A and the user terminal B to resolve, and the user terminal A and the user terminal B send the resolution to the server 2.

After the queuing module 105 determines that the conflict determination process is completed, the edit operation commands are added to the operation queue. The edit operation commands are arranged in the operation queue according to a time of receiving the edit operation commands. In another embodiment, the edit operation commands are arranged in the operation queue according to a preset order of edit operations or a preset order of edit positions.

The first sending module 106 is implemented in the server 2 and sends the edit operation commands to the user terminals 1 according to the operation queue.

For example, the first sending module 106 sends the edit operation command of the user terminal A to the user terminal B, and sends the edit operation command of the user terminal B to the user terminal A.

The second receiving module 107 is implemented in the user terminals 1 and receives the edit operation commands and update the document according to the edit operation commands.

For example, the user terminal A receives the edit operation command of the user terminal B, wherein the edit operation command of the user terminal B is to delete the A2 column of the document “annual report”.

In one embodiment, the edit operation commands are received according to a preset rule in the respective user terminals 1.

The preset rule may be used to determine whether the edit operation commands need to be received according to the priority of the user terminals, the IP address of the user terminals, and the like.

For example, the user terminal A receives the edit operation command of the user terminal B to delete the A2 column of the document “annual report”. If the user terminal A has the priority to receive the edit operation command of the user terminal B, the user terminal A runs the edit operation command of the user terminal B and updates the document according to the edit operation command.

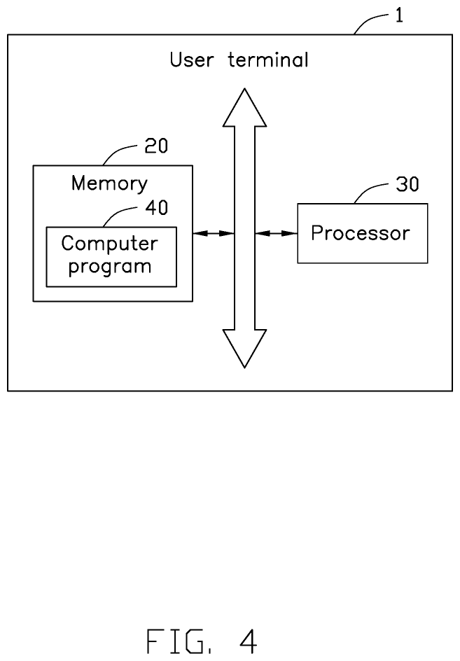

FIG. 4 is a block diagram of a user terminal 1.

The user terminal 1 includes a memory 20, a processor 30, and a computer program 40. When the processor 30 executes the computer program 40, the blocks in the collaborative document editing method may be implemented. Alternatively, when the processor 30 executes the computer program 40, the functional modules in the collaborative document editing program 10 may be implemented.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

1. A collaborative document editing method comprising:
distributing, by a server, a collaborative editing task to at least two user terminals, wherein the collaborative editing task comprises at least one document to be collaboratively edited by the at least two user terminals;
obtaining, by the at least two user terminals, a local operation record of the at least two user terminals;
sending, by the at least two user terminals, the local operation records to the server, wherein the server records the local operation records;
receiving, by the server, an edit operation command from the at least two user terminals, the edit operation command corresponding to the local operation record of the respective user terminal;
adding, by the server, the edit operation commands of the at least two user terminals to an operation queue;
sending, by the server, the edit operation commands to the at least two user terminals according to the operation queue; and
receiving, by the at least two user terminals, the edit operation commands according to the operation queue and updating the document according to the local operation record corresponding to the edit operation commands
wherein the method further comprises:
performing a conflict determination process on the edit operation commands sent by the at least two user terminals before adding the edit operation commands to the operation queue; and
resolving a conflict according to a preset program if there is the conflict, and then sending the resolved conflict to the user terminals;
wherein the preset program resolves the conflict according to types of edit operations, a priority of each of the types of edit operations, a sequence of the edit operations, and a priority of each of the at least two user terminals.

2. The collaborative document editing method of claim 1, wherein:
the edit operation commands are received according to a preset rule in the respective user terminals.

3. The collaborative document editing method of claim 1, wherein:
the collaborative document editing task comprises document names, the user terminals to edit the documents, and edit positions of the documents;
the local operation record comprises the document names, edit operations, contents of the edit operations, types of the edit operations, edit positions, and edit completion times of the edited documents; and
the documents comprise spreadsheet documents, rich text documents, and presentation documents.

4. The collaborative document editing method of claim 1, wherein:
before distributing the collaborative editing task, a first user terminal sends a request to the server to add at least one second user terminal to the collaborative editing task, the request comprising the document name, an IP address of the at least one second user terminal to add to the collaborative editing task, an edit position of the document, and an edit time; and
the server distributes the collaborative editing task to the first user terminal and the at least one second user terminal.

5. The collaborative document editing method of claim 1, further comprising:
adding the edit operation commands to the operation queue if there is no conflict;
sending the edit operation commands back to the at least two user terminals if there is a conflict which cannot be resolved according to the preset program;
wherein there is a conflict if a same edit position is edited by more than one user terminal in the edit operation commands.

6. The collaborative document editing method of claim 5, wherein the resolving the conflict according to the preset program comprises:
determining a type of each of the edit operations in the conflict;
determining a priority of each of the edit operations by searching a database according to the type of each of the edit operations;
saving the edit operation having a higher priority and more recent edit time according to the priority of each of the edit operations and the edit time of each of the edit operations.

7. The collaborative document editing method of claim 5, wherein the resolving the conflict according to the preset program comprises:
determining a priority of each of the at least two user terminals in the conflict according to a database; and
saving the edit operation of the user terminal having the higher priority.

8. A collaborative document editing system comprising:
a server; and
at least two user terminals communicatively coupled to the server through a network, wherein:
the server distributes a collaborative editing task to the at least two user terminals, the collaborative editing task comprising at least one document to be collaboratively edited by the at least two user terminals;
the at least two user terminals send local operation records to the server;
the server records the local operation records of the at least two user terminals;
the server receives an edit operation command from the at least two user terminals, the edit operation command corresponding to the local operation record of the respective user terminal;
the server adds the edit operation commands of the at least two user terminals to an operation queue and sends the edit operation commands to the at least two user terminals according to the operation queue; and
the at least two user terminals receive the edit operation commands according to the operation queue and update the document according to the local operation record corresponding to the edit operation commands;
wherein the server performs a conflict determination process on the edit operation commands sent by the at least two user terminals before adding the edit operation commands to the operation queue; and
the server resolves the conflict according to a preset program if there is the conflict, and then sends the resolved conflict to the user terminals;
wherein the preset program resolves the conflict according to types of edit operations, a priority of each of the types of edit operations, a sequence of the edit operations, and a priority of each of the at least two user terminals.

9. The collaborative document editing system of claim 8, wherein:
the edit operation commands are received according to a preset rule in the respective user terminals.

10. The collaborative document editing system of claim 8, wherein:
the collaborative document editing task comprises document names, the user terminals to edit the documents, and edit positions of the documents;
the local operation record comprises the document names, edit operations, contents of the edit operations, types of the edit operations, edit positions, and edit completion times of the edited documents; and
the documents comprise spreadsheet documents, rich text documents, and presentation documents.

11. The collaborative document editing system of claim 8, wherein:
before distributing the collaborative editing task, a first user terminal sends a request to the server to add at least one second user terminal to the collaborative editing task, the request comprising the document name, an IP address of the at least one second user terminal to add to the collaborative editing task, an edit position of the document, and an edit time; and
the server distributes the collaborative editing task to the first user terminal and the at least one second user terminal.

12. The collaborative document editing system of claim 8, wherein:
the server adds the edit operation commands to the operation queue if there is no conflict;
the server sends the edit operation commands back to the at least two user terminals if there is a conflict which cannot be resolved according to the preset program; and
there is a conflict if a same edit position is edited by more than one user terminal in the edit operation commands.

13. The collaborative document editing system of claim 12, wherein the resolving the conflict according to the preset program comprises:
determining a type of each of the edit operations in the conflict;
determining a priority of each of the edit operations by searching a database according to the type of each of the edit operations;
saving the edit operation having a higher priority and more recent edit time according to the priority of each of the edit operations and the edit time of each of the edit operations.

14. The collaborative document editing system of claim 12, wherein the resolving the conflict according to the preset program comprises:
determining a priority of each of the at least two user terminals in the conflict according to a database; and
saving the edit operation of the user terminal having the higher priority.
